(19) United States
(12) Patent Application Publication
(10) Pub. No.: US 2023/0325038 A1
(43) Pub. Date: Oct. 12, 2023

(54) WIRELESS HANDWRITING SCREEN

(71) Applicant: DAIYUN CHEN, Shenzhen (CN)

(72) Inventor: DAIYUN CHEN, Shenzhen (CN)

(21) Appl. No.: 18/079,062

(22) Filed: Dec. 12, 2022

(30) Foreign Application Priority Data
Apr. 7, 2022 (CN) 202220801435.6

(51) Int. Cl. G06F 3/044; G06F 3/046

(52) U.S. Cl. CPC G06F 3/044; G06F 3/046

(57) ABSTRACT

A wireless handwriting screen, comprising a display unit, an image unit, a coordinate unit, and a power supply unit; the image unit is arranged on one side of the display unit; the image unit is configured to transmit image signals to an interface end of the display unit; the coordinate unit is arranged on one side of the image unit; an image transmission unit is connected to the image unit through an wireless transmission unit; the coordinate unit is configured to record coordinates and transmit the coordinates through the wireless transmission unit; the power supply unit is arranged between the display unit, the image unit and the coordinate unit; a plurality of connection ends is arranged on outer peripheral side of the power supply unit, and the plurality of connection ends are correspondingly connected to the display unit, the image unit and the coordinate unit.

### CROSS-REFERENCE TO RELATED APPLICATIONS

This application claims the benefit and priority of Chinese patent application. No. 202220801435.6, filed on Apr. 7, 2022, disclosure of which is hereby incorporated by reference in its entirety.

### TECHNICAL FIELD

The present application relates to the technical field of wireless handwriting screens, and in particular, to a wireless handwriting screen.

### BACKGROUND

With the development of science and technology, handwriting screens are used in people's lives and displayed in combination with monitors. The handwriting screen only has an internal computing part, and the display needs to be purchased by the user separately, and the display needs to be manually docked with the handwriting screen. In this case, the existing handwriting screen alone cannot be displayed, resulting in a high usage cost of the handwriting screen.

### SUMMARY

In order to solve the above-mentioned technical problems, the application adopts the following technical solutions:

According to one aspect of the present application, the present application provides a wireless handwriting screen, comprising:
a display unit, comprised an interface end, the interface end is composed of a liquid crystal glass, a backlight module and a first power supply module, and the backlight module acts on the liquid crystal glass in the power supply of the first power supply module, and the interface end is used for UI;
an image unit, arranged on one side of the display unit; the image unit is configured to transmit image signals to the interface end;
a coordinate unit, arranged on one side of the image unit; the coordinate unit is connected to the image unit through a wireless transmission unit; the coordinate unit is configured to record the coordinates, and transmit the coordinates through the wireless transmission unit;
a power supply unit, arranged between the display unit, the image unit and the coordinate unit; a plurality of connection ends are arranged on outer peripheral side of the power supply unit, and the plurality of connection ends are correspondingly connected to the display unit, the image unit and the coordinate unit.

Alternatively, the backlight module outputs imaging signals to the liquid crystal glass under the connection of the first power module, and the liquid crystal glass receives the imaging signals, and presents an interface to outside world.

Alternatively, the image unit is arranged on right side of the display unit, and is electrically connected to the display unit through a line; the image unit and the display unit are arranged in sequence in the horizontal direction.

Alternatively, the coordinate unit, the image unit, the wireless transmission unit, and the display unit are sequentially enclosed to form a square area; the power supply unit is located in the center of the square area, and the plurality of connection ends of the power supply unit extends outward in different directions.

Alternatively, the coordinate unit and the display unit are arranged side by side in a vertical direction.

Alternatively, the wireless transport unit and the image unit are arranged side by side in a vertical direction.

Alternatively, the coordinate unit is an electromagnetic coordinate unit or a capacitance coordinate unit.

As can be seen from the above technical solutions, the embodiments of the present application at least have the following advantages and positive effects:

In the wireless handwriting screen of the embodiment of the present application, the image unit is arranged on one side of the display unit; the image unit is configured to transmit image signals to the interface end of the display unit; the coordinate unit is arranged on one side of the image unit; the image transmission unit is connected to the image unit through the wireless transmission unit; the coordinate unit is configured to record the coordinates, and transmit the coordinates through the wireless transmission unit; the power supply unit is arranged between the display unit, the image unit and the coordinate unit; a plurality of connection ends are arranged on outer peripheral side of the power supply unit, and the plurality of connection ends are correspondingly connected to the display unit, the image unit and the coordinate unit, wherein the display unit is a part of the wireless handwriting screen, and works based on the interaction of the image unit, the coordinate unit and the power supply unit, and the wireless handwriting screen is avoided to be externally connected to a display component, thereby reducing the use cost of the wireless handwriting screen.

### BRIEF DESCRIPTION OF DRAWINGS

in order to more clearly illustrate the embodiments of the present application or the technical solutions in the prior art, the following briefly introduces the accompanying drawings that need to be used in the description of the embodiments or the prior art. Obviously, the drawings in the following description are only some embodiments of the present application. For those of ordinary skill in the art, other drawings can also be obtained based on the structures shown in these drawings without any creative effort.

FIG. 1 is a schematic diagram of a wireless handwriting screen proposed by the present application.

The realization, functional characteristics and advantages of the purpose of the present application will be further described with reference to the accompanying drawings in conjunction with the embodiments.

### DETAILED DESCRIPTION

The technical solutions in the embodiments of the present application will be clearly and completely described below with reference to the drawings in the embodiments of the present application. Obviously, the described embodiments are only a part of the embodiments of the present application, but not all of the embodiments. Based on the embodiments in the present application, all other embodiments obtained by those of ordinary skill in the art without creative work fall within the protection scope of the present application.

With the development of science and technology, handwriting screens are used in people's lives and displayed in combination with monitors. The handwriting screen only has an internal computing part, and the display needs to be purchased by the user separately, and the display needs to be manually docked with the handwriting screen. In this case, the existing handwriting screen alone cannot be displayed, resulting in a high usage cost of the handwriting screen.

In addition, the traditional handwriting screen is generally connected to a desktop computer or a notebook computer by wire as an extended use function of the original display. With the development of science and technology, 60G wireless image transmission technology can realize high-quality image (4K/UHD) low-latency transmission (less than 10 milliseconds) between the computer host and the handwriting screen, which can satisfy users to get rid of the limitations of traditional wiring harnesses. Combined with the mature 2.4G Bluetooth wireless coordinate transmission technology, it can perfectly meet the user needs of wireless handwriting display. To some extent, the user can save the original display, and only one wireless handwriting screen can meet the user's needs in the field of handwriting screen, which saves the cost for the user.

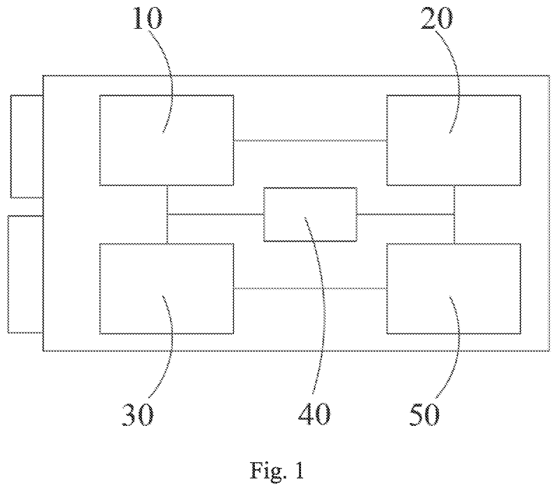

Please refer to FIG. 1, the present application provides a wireless handwriting screen, the wireless handwriting screen comprises a display unit 10, an image unit 20, a coordinate unit 30, and a power supply unit 40. At this time, the display unit 10, the image unit 20, the coordinate unit 30, and the power supply unit 40 are electrically connected to each other.

The display unit 10 has an interface end, which is used to display the interface and convert the image signal into an interface, wherein the interface end is composed of a liquid crystal glass, a backlight module and a first power supply module, and the backlight module outputs imaging signals to the liquid crystal glass under the connection of the first power module. Optionally, the interface end has a built-in first power supply module, and realizes independent power supply based on the first power supply module. The display unit 10 may reserve general image interfaces such as independent HDMI/DP and TYPE-C.

The backlight module outputs imaging signals to the liquid crystal glass under the connection of the first power module, and the liquid crystal glass receives the imaging signals, and presents an interface to outside world.

The image unit 20 is arranged on one side of the display unit; the image unit 20 is arranged on right side of the display unit 10, and is electrically connected to the display unit 10 through a line; the image unit 20 and the display unit 10 are arranged in sequence in the horizontal direction. The image unit 20 is used to transmit the image signal to the interface end, and the interface end converts the image signal into an interface. At this time, the image unit 20 transmits the signal based on the signal channel with the interface end. Optionally, the image unit 20 may be a 60G wireless image unit, and the antenna arrangement of the 60G wireless image unit may be parallel to or vertically arranged with the display unit 10 in a vertical direction, which is not limited here.

The coordinate unit 30 is arranged on one side of the image unit 20; the coordinate unit 30 is connected to the image unit 20 through a wireless transmission unit 50; the coordinate unit 30 is configured to record the coordinates, and transmit the coordinates through the wireless transmission unit 50. Optionally, the electromagnetic coordinate unit 30 is a system that uses the electromagnetic coordinate identification technology EMR to identify coordinates; the capacitance coordinate unit 30 is a system that uses the capacitance coordinate identification technology TP to identify the coordinates. Optionally, the wireless transmission unit is a 2.4G Bluetooth wireless transmission unit.

The power supply unit 40 is arranged between the display unit 10, the image unit 20 and the coordinate unit 30; the outer peripheral side of the power supply unit 40 is provided with a plurality of connection ends, and the plurality of connection ends are correspondingly connected to the display unit 10. The image unit 20 and the coordinate unit 30.

The coordinate unit 30, the image unit 20, the wireless transmission unit 50, and the display unit 10 are sequentially enclosed to form a square area; the power supply unit 40 is located in the center of the square area, and the plurality of connection ends extend outward in different directions. At this time, using one of the power supply units 40 to act on the coordinate unit 30, the image unit 20, the wireless transmission unit 50, and the display unit 10, and extend outward from the center of the square area, which effectively utilizes the space of the square area, and realizes a synchronous power supply for the coordinate unit 30, the image unit 20, the wireless transmission unit 50, and the display unit 10.

Optionally, the coordinate unit 30 and the display unit 10 are arranged side by side in a vertical direction. The wireless transmission unit 50 and the image unit 20 are arranged side by side in the vertical direction.

As can be seen from the above technical solutions, the embodiments of the present application at least have the following advantages and positive effects:

In the wireless handwriting screen of the embodiment of the present application, the image unit 20 is arranged on one side of the display unit 10; the image unit 20 is configured to transmit image signals to the interface end of the display unit 10; the coordinate unit 30 is arranged on one side of the image unit 20; the image transmission unit is connected to the image unit 20 through the wireless transmission unit 50; the coordinate unit 30 is configured to record the coordinates, and transmit the coordinates through the wireless transmission unit 50; the power supply unit 40 is arranged between the display unit 10, the image unit 20 and the coordinate unit 30; a plurality of connection ends are arranged on outer peripheral side of the power supply unit 40, and the plurality of connection ends are correspondingly connected to the display unit 10, the image unit 20 and the coordinate unit 30, wherein the display unit 10 is a part of the wireless handwriting screen, and works based on the interaction of the image unit 20, the coordinate unit 30 and the power supply unit 40, and the wireless handwriting screen is avoided to be externally connected to a display component, thereby reducing the use cost of the wireless handwriting screen.

The above descriptions are only optional embodiments of the present application, which are not intended to limit the patent scope of the present application. All equivalent structural transformations made by using the contents of the description and drawings of the present application under the concept of the present application, or directly/indirectly applied in other related technical fields are included in the scope of patent protection of the present application.

What is claimed is:

1. A wireless handwriting screen, comprising:
a display unit, comprised an interface end, the interface end is composed of a liquid crystal glass, a backlight module and a first power supply module, and the backlight module acts on the liquid crystal glass in the power supply of the first power supply module, and the interface end is used for UI;
an image unit, arranged on one side of the display unit; the image unit is configured to transmit image signals to the interface end;
a coordinate unit, arranged on one side of the image unit; the coordinate unit is connected to the image unit through a wireless transmission unit; the coordinate unit is configured to record the coordinates, and transmit the coordinates through the wireless transmission unit;
a power supply unit, arranged between the display unit, the image unit and the coordinate unit; a plurality of connection ends are arranged on outer peripheral side of the power supply unit, and the plurality of connection ends are correspondingly connected to the display unit, the image unit and the coordinate unit.

2. The wireless handwriting screen according to claim 1, wherein the backlight module outputs imaging signals to the liquid crystal glass under the connection of the first power module, and the liquid crystal glass receives the imaging signals, and presents an interface to outside world.

3. The wireless handwriting screen according to claim 1, wherein the image unit is arranged on right side of the display unit, and is electrically connected to the display unit through a line; the image unit and the display unit are arranged in sequence in the horizontal direction.

4. The wireless handwriting screen according to claim 3, wherein the coordinate unit, the image unit, the wireless transmission unit, and the display unit are sequentially enclosed to form a square area; the power supply unit is located in the center of the square area, and the plurality of connection ends of the power supply unit extends outward in different directions.

5. The wireless handwriting screen according to claim 3, wherein the coordinate unit and the display unit are arranged side by side in a vertical direction.

6. The wireless handwriting screen according to claim 3, wherein the wireless transport unit and the image unit are arranged side by side in a vertical direction.

7. The wireless handwriting screen according to claim 1, wherein the coordinate unit is an electromagnetic coordinate unit or a capacitance coordinate unit.
